(19) United States
(12) Patent Application Publication
(10) Pub. No.: US 2014/0181992 A1
(43) Pub. Date: Jun. 26, 2014

(54) MULTI-TENANT CONTENT PROVIDER

(71) Applicants: Michael Alexander Janson, Berkeley, CA (US); Ian David Robert Fisher, San Rafael, CA (US); Christopher Michael O'Connor, Burlingame, CA (US); Daniel William James McCall, San Rafael, CA (US); John Jacob Ellenich, San Francisco, CA (US)

(72) Inventors: Michael Alexander Janson, Berkeley, CA (US); Ian David Robert Fisher, San Rafael, CA (US); Christopher Michael O'Connor, Burlingame, CA (US); Daniel William James McCall, San Rafael, CA (US); John Jacob Ellenich, San Francisco, CA (US)

(21) Appl. No.: 13/725,029

(22) Filed: Dec. 21, 2012

(51) Int. Cl. G06F 21/60

(52) U.S. Cl. CPC G06F 21/60
USPC 726/27

(57) ABSTRACT

Methods, systems, and apparatus, including computer programs encoded on a computer storage medium, for receiving a user login request originating from a user device, the user login request including a user identifier; authenticating, based on the user identifier, the user as having access to information associated with a particular tenant of a plurality of tenants; identifying a tenant specified theme associated with the particular tenant of a plurality of tenant themes, the theme being specified by the tenant for use in presenting data to authenticated users; obtaining data associated with the particular tenant; and providing the data associated with the particular tenant to the user device for presentation, wherein the data is presented on a user interface of the user device, the data being formatted based on the identified tenant theme.

### BACKGROUND

This specification relates to information retrieval.

Authorized users can access a company's servers to obtain data associated with the company. Some examples of data that can be obtained from a company's server include e-mail, calendars, and company directories.

### SUMMARY

Users can access a multi-tenant system to obtain information about individuals (e.g., employees) and/or resources (e.g., conference rooms) that are associated with particular tenants, e.g., company organizations. In particular, the multi-tenant system can provide information to various users associated with particular tenants among multiple distinct tenants of the multi-tenant system. For example, users can access the multi-tenant system to obtain a particular employee's name, title, contact information, department information, team information, and supervisor information. Similarly, users can access the multi-tenant system to obtain a conference room name, location information, availability information, conference room images, and a description of the conference room's features.

The multi-tenant system can authenticate a user as having access to information associated with a particular tenant, and can process user requests for information that is associated with the particular tenant. The multi-tenant system can process user requests using information stored in a cache or by obtaining the information directly from data storage, e.g., servers associated with the particular tenant. The multi-tenant system can provide the requested information to the user for presentation in an interface, e.g., a web browser or an interface on a user device. Further, the multi-tenant system can format the requested information using one or more tenant themes that were identified by the particular tenant.

In general, one aspect of the subject matter described in this specification can be embodied in methods that include the actions of receiving a user login request originating from a user device, the user login request including a user identifier; authenticating, based on the user identifier, the user as having access to information associated with a particular tenant of a plurality of tenants; identifying a tenant specified theme associated with the particular tenant of a plurality of tenant themes, the theme being specified by the tenant for use in presenting data to authenticated users; obtaining data associated with the particular tenant; and providing the data associated with the particular tenant to the user device for presentation, wherein the data is presented on a user interface of the user device, the data being formatted based on the identified tenant theme. Other embodiments of this aspect include corresponding systems, apparatus, and computer program products.

These and other embodiments can optionally include one or more of the following features. The method further includes receiving a user request for tenant data; obtaining tenant data responsive to the request; and providing the response to the user device, wherein the response is presented in the user interface on the user device, the response being formatted based on the particular tenant theme. The user request is for information associated with one or more individuals that are associated with the particular tenant. Obtaining data associated with the particular tenant includes obtaining profile and group information for a plurality of individuals associated with the particular tenant. The information associated with the one or more individuals includes one or more of a respective name, title, contact information, department information, team information, or supervisor information for respective users of the one or more individuals. At least a portion of the information associated with the one or more individuals is stored in a cache, and obtaining tenant data responsive to the request includes determining a responsive portion of the data stored in the cache. When responsive data cannot be determined from the cache, obtaining tenant data responsive to the request from data processing apparatus associated with the particular tenant.

The method further includes updating the cache to include the obtained data responsive to the request. The particular tenant theme defines, for the particular tenant, a graphical user interface configuration, including one or more of logo images, background images, or a color scheme. The user request is for information associated with one or more conference rooms that are associated with the particular tenant. Obtaining data associated with the particular tenant includes obtaining a listing of the one or more conference rooms. The information associated with one or more conference rooms includes a respective conference room name, location information, availability information, one or more conference room images, and a description of conference room features. The method further includes receiving a conference room reservation request from a user operating the user device, the conference room reservation request specifying a particular conference room and a reservation duration; determining whether the particular conference room is available for the reservation duration; and in response to determining that the particular conference room is available for the reservation duration, reserving the particular conference room for the reservation duration.

Particular embodiments of the subject matter described in this specification can be implemented so as to realize one or more of the following advantages. Users associated with different company organizations (tenants) can access a multi-tenant system to obtain information associated with the different company organizations. Users can also access the multi-tenant system to view information relating to resources, e.g., conference rooms, associated with a particular tenant. Users can use the multi-tenant system to identify conference rooms that are available at a particular time, and can use the multi-tenant system to reserve conference rooms. Users associated with a tenant can be presented data using one of themes selected by the tenant.

The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a block diagram of an example system that can provide content associated with multiple tenants.

FIG. 2 is a swim lane diagram illustrating an example user authentication process.

FIG. 3 is a swim lane diagram illustrating an example processing of a user request.

FIG. 4 illustrates an example interface for presenting information describing individuals that are associated with a particular tenant.

FIG. 5 illustrates an example interface for accessing group information.

FIG. 6 illustrates an example interface for accessing group information from a profile of a particular individual.

FIG. 7 illustrates an example interface for accessing team information from a profile of a particular individual.

FIG. 8 illustrates an example interface for accessing ladder information from a profile of a particular individual.

FIG. 9 illustrates an example interface for presenting information that describes conference rooms associated with a particular tenant.

FIG. 10 illustrates an example interface for presenting information that describes conference rooms associated with a particular tenant.

FIG. 11 illustrates an example interface for presenting information that describes conference rooms associated with a particular tenant.

FIGS. 12A-12B illustrate an example interface for extending a conference room reservation time.

FIG. 13 illustrates an example interface for scheduling a follow-up conference room meeting.

Like reference numbers and designations in the various drawings indicate like elements.

### DETAILED DESCRIPTION

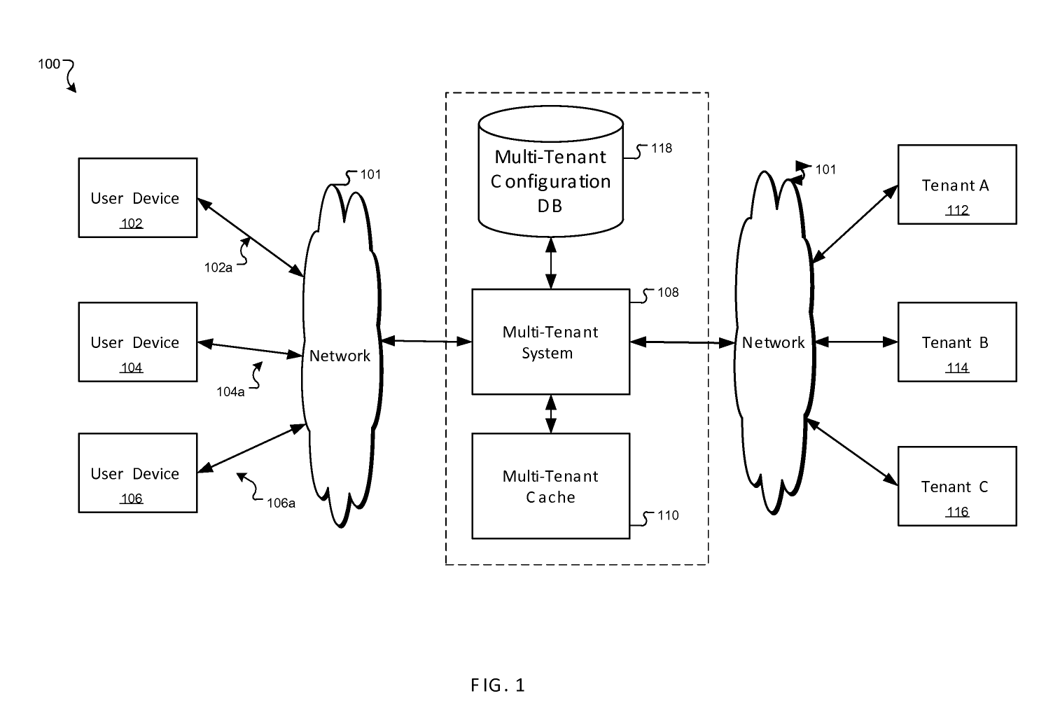

FIG. 1 is a block diagram of an example system 100 that can provide content associated with multiple tenants. The system 100 is an example of a multi-tenant content providing system implemented as one or more computer programs on one or more computers in one or more locations, in which the systems, components, and techniques described below can be implemented. The multi-tenant content providing system 100 includes a multi-tenant system 108 that is configured to communicate with one or more tenant servers 112, 114, and 116 through a network 101.

Each tenant server 112, 114, and 116 is associated with a different tenant. A tenant corresponds to a particular client organization, e.g., a particular corporation or associated entity. Each tenant server 112, 114, and 116 can store various tenant data describing the respective tenant in one or more databases.

As used in this specification, the term “database” will be used broadly to refer to any collection of data: the data does not need to be structured in any particular way, or structured at all, and it can be stored on storage devices in one or more locations. The network 101 can be a local area network (LAN), a wide area network (WAN), the Internet, one or more telephony or wireless networks, or a combination thereof.

One example of tenant data stored by a particular tenant server is data describing individuals that are associated with the tenant, e.g., employees of the tenant. In some implementations, the data describing an individual includes one or more of an individual name, user identifier, one or more email addresses, job title, one or more phone numbers, address information, department information, or one or more images relating to individuals. The data can also include team information, e.g., a listing of other individuals that are associated with the same team as the individual, or ladder information, e.g., a hierarchical listing describing the individual's supervisors and subordinates.

Another example of tenant data stored by a particular tenant server is data describing resources that are associated with the tenant, e.g., conference rooms at one or more tenant locations. In some implementations, the data describing conference rooms includes a conference room name, conference room location information, e.g., geographical coordinates describing the conference room location in a tenant's building, room capacity, resources available in the conference room, conference room availability information, e.g., times during which the conference room is or is not available, one or more user identifiers of individuals that have booked the conference room, or data describing individuals that are scheduled to be in the conference room at a particular time.

In some implementations, the multi-tenant system 108 manages the reservation of resources, e.g., conference rooms, for tenants. For example, the multi-tenant system 108 can obtain data describing resources, e.g., conference room names, locations, and resources available in the conference rooms from tenant servers associated with tenants. In such implementations, reservations, or scheduling changes, of resources are coordinated by the multi-tenant system 108, which maintains scheduling information for a tenant's resources in a local database, e.g., multi-tenant cache 110.

The multi-tenant system 108 is configured to obtain tenant data from the respective tenant servers 112, 114, and 116. The tenant data can include data describing the individuals and resources that are associated with the respective tenant. The multi-tenant system 108 can be configured to access each respective tenant server 112, 114, and 116 using access credentials, e.g., a host name, port number, and login credentials. In some implementations, the access information for a tenant server 112, 114 and 116, is provided by a respective tenant using an administrator console interface, as described below. Once the multi-tenant system 108 is configured to access a tenant server 112, 114, and 116, data can be obtained from the respective tenant server 112, 114, and 116 using, for example, a directory access protocol, e.g., Lightweight Directory Access Protocol (LDAP).

In some cases, a tenant may not have an available server from which the multi-tenant system 108 can obtain tenant data, e.g., data describing individuals associated with the tenant and/or tenant resources. Thus, in some implementations, the tenant can provide the tenant data to the multi-tenant system 108 in one or more data files, e.g., comma-separate value (CSV) files, that are uploaded to the multi-tenant system 108. The data files can be provided by the tenant either manually or automatically at specified time intervals.

The multi-tenant system 108 is also configured to communicate with a multi-tenant cache 110. The multi-tenant cache 110 can be used to store and retrieve data that was obtained from a tenant server. For example, in response to a user request for tenant data, the multi-tenant system 108 and identify and provide information stored in the multi-tenant cache 110 rather than directly requesting the data form the corresponding tenant. In some implementations, the multi-tenant system 108 stores, in the multi-tenant cache 110, portions of the data obtained from the tenant servers 112, 114, and 116 and the data provided by the tenants in data files. For example, the multi-tenant system 108 can store, in the multi-tenant cache 110, data that was obtained from a tenant server when servicing a user request. In some implementations, the multi-tenant cache 110 is configured to store the data for a specified period of time. The period of time can be a global system parameter or may be specified by a tenant. Depending on the implementation, certain types of data can be cached differently. For example, some types of cached data, e.g., conference room scheduling data, can expire after a specified period of time while some types of cached data can have a different expiration time including never expiring, e.g., data describing names of conference rooms.

In some implementations, the multi-tenant system stores, in the multi-tenant cache 110, static data, e.g., data that generally does not change over a specified period of time. For example, the multi-tenant system can store data describing conference rooms associated with a particular tenant, e.g., conference room names, locations, room capacity, and resources available in the conference rooms. In such implementations, data that generally changes over a specified period of time, e.g., conference room availability information, can be obtained from a tenant server associated with the particular tenant on an as-needed basis. In some implementations, data from a cache is combined with specifically obtained data to provide to a requesting user. For example, for a conference room request, static information on room names and locations can be joined with obtained current availability information. This can reduce the amount of data and/or bandwidth needed to facility information requests from users of the multi-tenant system 108.

Users operating user devices 102, 104, and 106 can communicate with the multi-tenant system 108 through the network 101, e.g., using wi-fi, 3G, 4G, etc. The user device 102, 104, and 106 will generally include a memory, e.g., a random access memory (RAM), for storing instructions and data and a processor for executing stored instructions. The memory can include both read only and writable memory. The user device 102, 104, and 106 can respectively be one of various types of computing devices, e.g., a cloud client device, a smartphone, a tablet device, or a personal digital assistant.

The user devices 102, 104, and 106 can run an application program, e.g., a web browser or mobile application, that can interact with the multi-tenant system 108 to obtain data associated with the tenants, for example, employee or conference room information. The multi-tenant system 108 can provide the requested data to the user devices 102, 104, and 106 for presentation within a user interface provided by a display of the user device. Users can interact with the interface, e.g., scroll and/or provide input, using, for example, a track wheel or keypad. The user interface can be also presented on a touch-sensitive display of the user device and users can interact with the interface using, for example, touch and/or swipe gestures.

In some implementations, all communication and data transmission exchanged between the user devices 102, 104, or 106; the multi-tenant system 108; and the tenant servers 112, 114, or 116 is encrypted. Further, the multi-tenant system 108 can be configured to monitor and throttle communications to maintain system integrity, e.g., using logging, analytics, system performance, threat detection, and limiting the processing of user requests directed to a particular tenant based on a threshold number of user requests received for the particular tenant over a specified time period. The multi-tenant system 108 can also be configured to load balance operations over two or more servers, e.g., servers in a cloud computing environment. For example, user requests can be load balanced based on the tenant, volume of user requests, and geographic location.

In some implementations, a user operating the user device 102, 104, or 106 can obtain data associated with a tenant by providing user login credentials 102a, 104a, or 106a, e.g., a user identifier and password, to an application program that is running on the user device. The user device provides the user login credentials to the multi-tenant system 108 to authenticate the user as having permission to access information associated with a particular tenant. In some implementations, the user login credentials are authenticated against an authentication database stored on the multi-tenant system 108. The multi-tenant system 108 can evaluate the user identifier, e.g., using a lookup database, to identify a tenant that is associated with the user. Additionally, the multi-tenant system 108 can compartmentalize tenant access such that the user access is limited to only the particular tenant and tenant data to which they are authorized.

In some implementations, the user identifier is a user's corporate e-mail address, e.g., “user@example-company.com,” and the system identifies the tenant associated with the user based on the tenant's domain name, e.g., “example-company.com,” included in the corporate e-mail address. In some implementations, once a tenant has been identified, the multi-tenant system 108 provides the user login credentials to the tenant server for the tenant to authenticate the user login credentials.

The multi-tenant system 108 can also communicate with a multi-tenant configuration database 118. Data describing tenant themes can be stored on the multi-tenant configuration database 118. In some implementations, when evaluating the user identifier to identify a tenant associated with a user, the multi-tenant system 108 can also identify, using the multi-tenant configuration database 118, a theme that is associated with the tenant. In some implementations, a theme defines, for a particular tenant, a graphical user interface configuration for presenting data associated with a particular tenant on a user device. The theme can provide a particular look and feel for the application that is specific to the tenant. The theme can include, for example, one or more of logo images, background images, and a color scheme. Each tenant can configure themes using an administrator console interface, as described below. In some implementations, a tenant can configure multiple, different themes, and users associated with the tenant can be presented data using one of the different themes, depending on the theme that was selected by, or assigned to, the user. A tenant can also configure different themes to be used depending on the type of data being requested by users. For example, a tenant can select a first theme for data describing individuals, e.g., employees, that are associated with the tenant, and a second theme for data describing resources, e.g., conference rooms, that are associated with the tenant.

Tenants can use an administrator console interface, e.g., a web-based interface, to configure the multi-tenant system 108 to access their respective tenant servers. A tenant can use the administrator console interface to configure licensing options for users seeking to obtain data associated with the tenant, manage one or more user lists, e.g., lists of authorized users and banned users, configure theme settings, and configure tenant server settings, e.g., LDAP configuration.

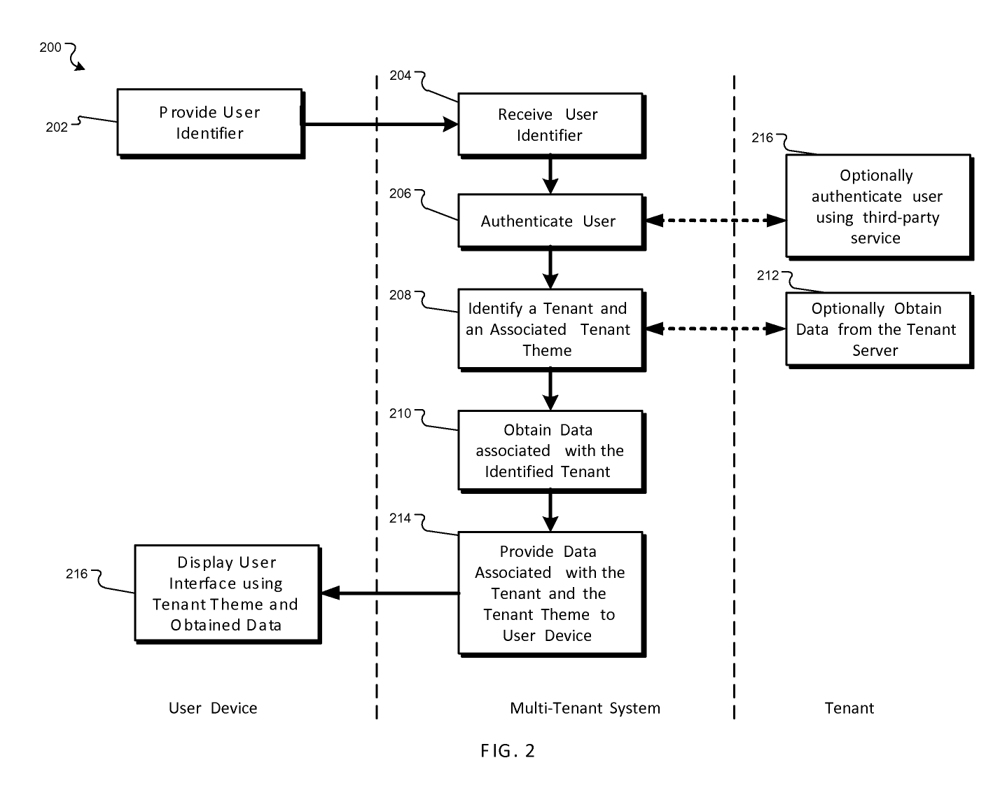

FIG. 2 is a swim lane diagram 200 illustrating an example user authentication process. A user operating a user device provides a user login request that includes a user identifier to a multi-tenant system (202). The user login request can be provided from a user device communicating over a network.

The multi-tenant system receives the user login request that was communicated by the user device over the network (204).

The multi-tenant system authenticates the user as having access to information associated with a particular tenant (206). The multi-tenant system can authenticate the user based on the user credentials, e.g., a user identifier can be used to identify the corresponding tenant while a user password can be used to authenticate the user. Depending on the implementation, the system can authenticate the user by itself or by using a tenant server associated with the particular tenant, as described above in reference to FIG. 1. In some implementations, the multi-tenant system interacts with a third-party authentication service to authenticate the user as having access to information associated with a particular tenant (216). The multi-tenant system can be configured to authenticate the user based on an authentication token that is provided to the multi-tenant system by the user or by a third-party authentication service. For example, the authentication token can be generated by the third-party authentication service after the user provides the third-party authentication service with the user's login credentials.

In some implementations, the user device is configured to store tenant data received from the multi-tenant system in a cache memory on the user device. In such implementations, the user login request can include a synchronization request to the multi-tenant system. In response to the synchronization request, the multi-tenant system can provide the user device data describing all database changes, e.g., inserts, updates, and deletes, for the particular tenant that have occurred since a particular timestamp. In some implementations, the data is provided to the user device in a time-ordered index. The data stored in the cache memory on the user device can be updated based on the database changes that have occurred since the user device's last update.

The system identifies a tenant specified theme associated with the particular tenant (208). The system can identify a tenant specified theme for the particular tenant using, e.g., the multi-tenant configuration database 118, as described in reference to FIG. 1. The system can identify a default theme in cases where a tenant does not have a specified theme.

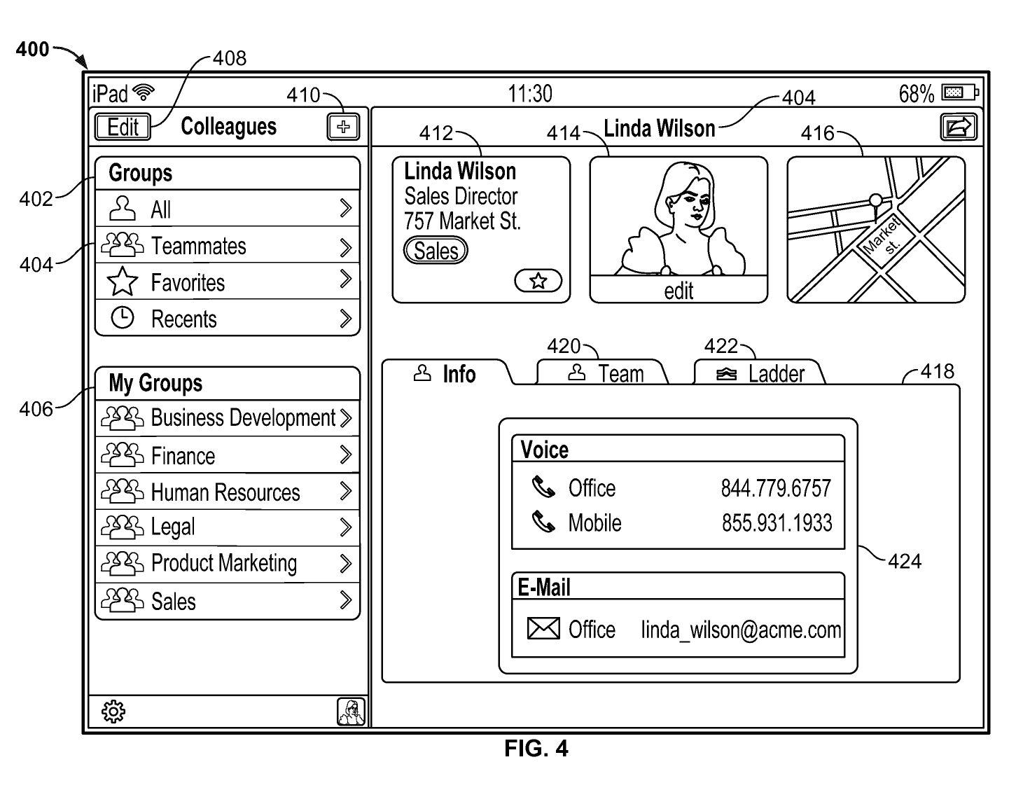

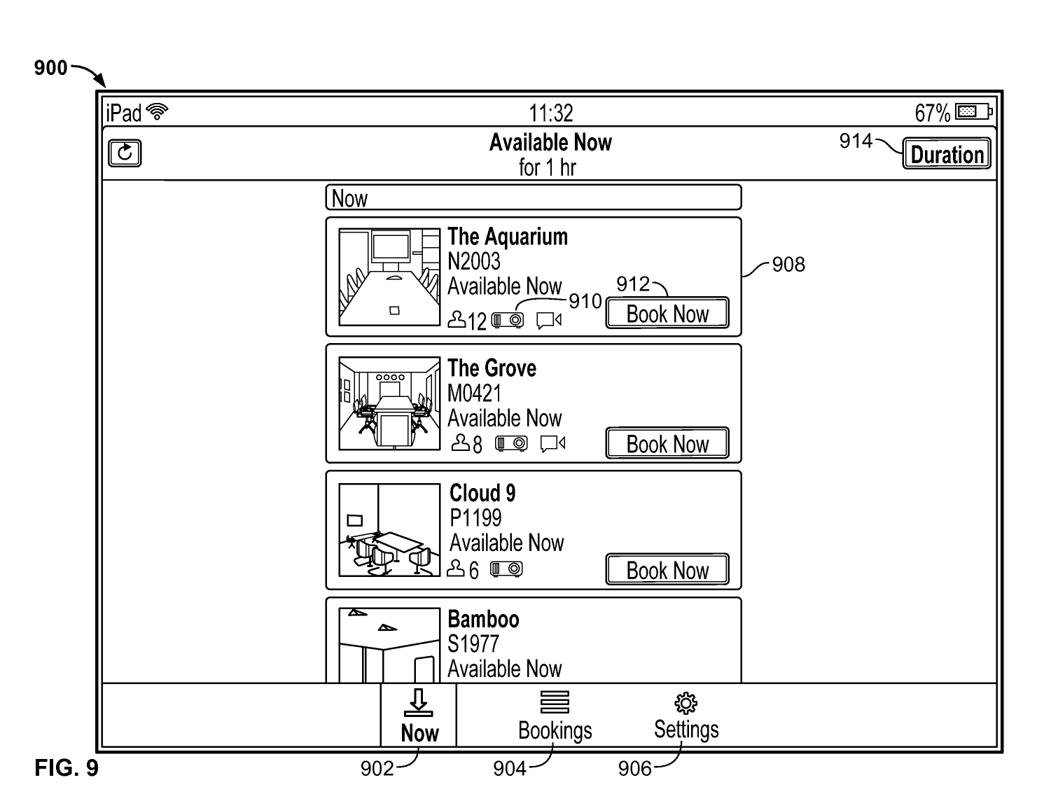

The system obtains data associated with the particular tenant (210). In some implementations, the system obtains profile and group information for individuals associated with the particular tenant, as described below in reference to FIGS. 4-8. In some implementations, the system obtains a listing of conference rooms associated with the particular tenant, as described below in reference to FIGS. 9-14.

In some implementations, a portion of data associated with a particular tenant is stored in a cache, e.g., the multi-tenant cache 110. In such implementations, the system first obtains the data associated with the particular tenant from a cache, e.g., the multi-tenant cache 110. If the requested data is not available in the cache, the system obtains the data from a tenant server associated with the particular tenant (212). In some implementations, the system updates the cache to include the data that was obtained from the tenant server.

In some implementations, before obtaining the data associated with the particular tenant from the cache, the system determines whether the data associated with the particular tenant that is stored in the cache is fresh, e.g., the data has been updated within a specified period of time. For example, the data can be determined to be fresh if the data was updated in the last 24 hours.

The system provides the data associated with the particular tenant to the user device for presentation (214). The system can communicate the data to the user device over the network. Once received, the user device can format the data based on the identified tenant theme and can present the data on a user interface of the user device. In formatting the data for presentation, the user device can modify an application template using the identified tenant theme. An application template can define, for example, layout information describing how data is presented on a graphical user interface and attributes of the interface. The user device can apply the particular tenant theme to the application template. For example, based on the identified tenant theme, the user device can apply the application template to present profile and group information for individuals associated with the particular tenant in a graphical user interface configuration that includes tenant specified logo images, background images, and color scheme.

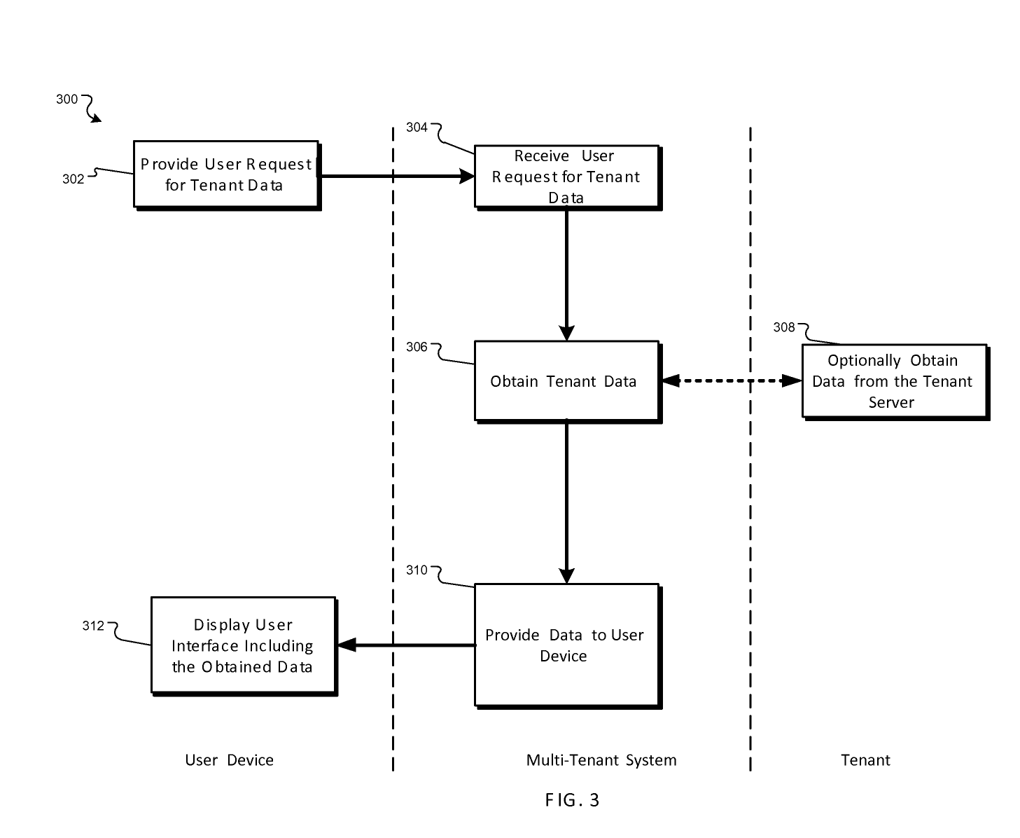

FIG. 3 is a swim lane diagram 300 illustrating an example processing of a user request. A user operating a user device provides a user request for tenant data associated with a particular tenant (302). For example, after a user is authenticated and provided with an initial interface, the user can interact with the displayed tenant data to request other data. The user request can be provided from a user device communicating over a network.

The multi-tenant system receives the user request that was communicated by the user device over the network (304). The multi-tenant system obtains tenant data responsive to the user request (306). In some implementations, the user request is for information associated with one or more individuals that are associated with a particular tenant. For example, the user can request information associated with an employee of the tenant. In some implementations, the user can request an individual's name, title, contact information, department information, team information, or supervisor information, as will be described below in reference to FIGS. 4-8.

In some other implementations, the user request is for information associated with one or more conference rooms that are associated with a particular tenant. For example, the user request can be for a listing of the one or more conference rooms. In some implementations, the user can request a particular conference room by name, e.g., a conference room number or name, location information, availability information, one or more conference room images, and a description of conference room features, as will be described below in reference to FIGS. 9-13.

In some implementations, the multi-tenant system first obtains the data associated with the particular tenant from a cache, e.g., the multi-tenant cache 110. If the requested data is not available in the cache, the system obtains the data from a tenant server associated with the particular tenant, as described above in reference to FIG. 2 (308).

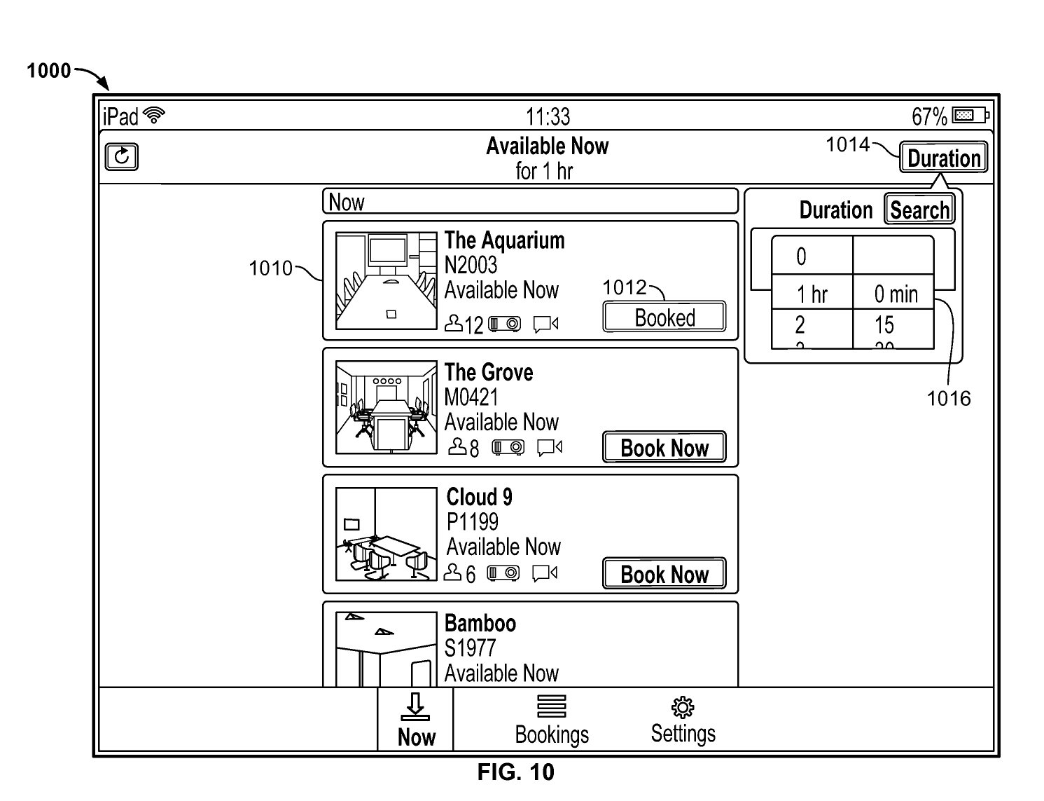

In some implementations, the user request is a conference room reservation request that specifies a particular conference room and a reservation duration. Upon receiving the request, the multi-tenant system determines whether the particular conference room is available for the reservation duration and, if the conference room is available, reserves the particular conference room for the reservation duration. Conference room reservation is described further in reference to FIG. 10.

The multi-tenant system provides the data responsive to the user request to the user device (310). The system can communicate the data to the user device over the network. Once received, the user device formats the data based on an application template and a theme associated with the particular tenant and presents the data on a user interface of the user device, as described in reference to FIG. 2 (312).

FIG. 4 illustrates an example interface 400 for presenting information describing individuals that are associated with a particular tenant. The interface can be provided in a company directory application program, e.g., a web browser or mobile application on a user device, that is configured to present information describing individuals and/or resources that are associated with a particular tenant. The information can be presented to a user on a user device, as described in reference to FIG. 1. The interface 400 includes a group information display 402 and a profile display 404. In FIG. 4, the interface 400 presents a user's information, e.g., “Linda Wilson,” in response to authentication a user login request from the user.

The group information display 402 includes a first listing of groups 404 that are associated with the user. Each group in the listing of groups 404 can include one or more individuals that were assigned to the group by the particular tenant or by the user. Some example group categories include an “All” group, e.g., a group that references to individuals that are associated with the particular tenant, a “Teammates” group, e.g., a group that references to individuals that are associated with the individual's team, a “Favorites” group, e.g., a group that references to individuals that the user has identified as favorites, and a “Recents” group, e.g., a group that references to individuals whose profile the user has recently accessed.

The group information display 402 also includes a second listing of groups 406 that are associated with the user. Groups in the second listing of groups 406 can categorize individuals by team or department, e.g., “Business Development,” “Finance,” “Human Resources,” “Legal,” “Product Marketing,” and “Sales.” The user can select the button 408 to edit the groups that are shown in the group information display 402, e.g., the user can add or remove individuals from a particular group, add a new group, remove an existing group, or rename a group.

The profile display 404 displays information associated with a particular individual. The profile display 404 includes a first region 412 for displaying information associated with the particular individual, e.g., individual name, job title, and contact information, a second region 414 for displaying one or more images associated with the particular individual, and a third region 416 for displaying a map interface that indicates a location of the particular individual, e.g., a business location or an actual location of the individual.

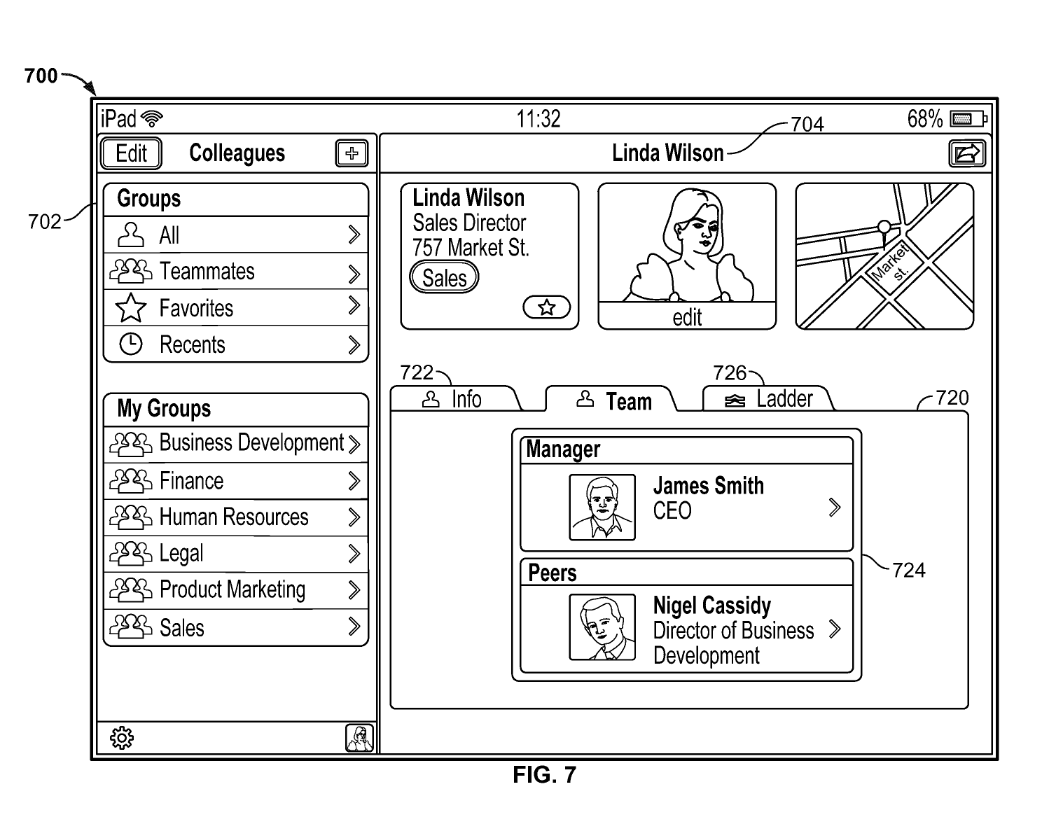

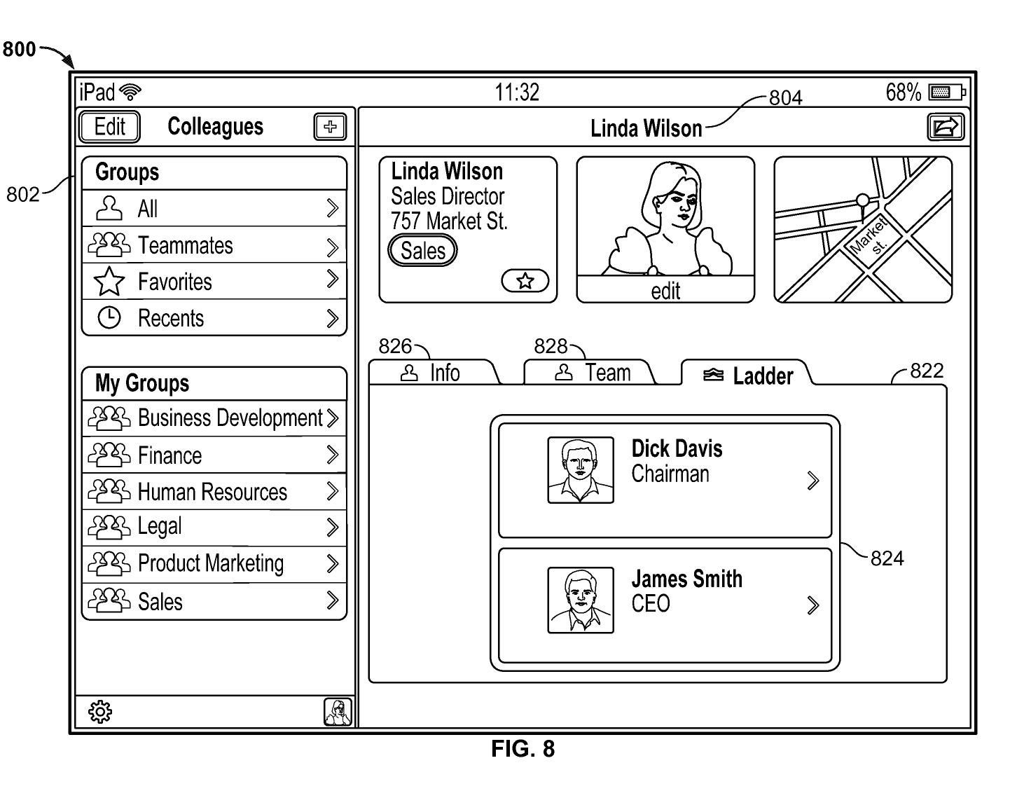

The profile display 404 also includes a fourth region 418 for displaying additional information 424 that is associated with the particular individual. In FIG. 4, the fourth region 404 displays additional contact information 424, e.g., phone numbers and email address, for the particular individual. The fourth region 418 also includes buttons or tabs 420 and 422 for accessing team and ladder information, respectively, as described below in FIGS. 7 and 8.

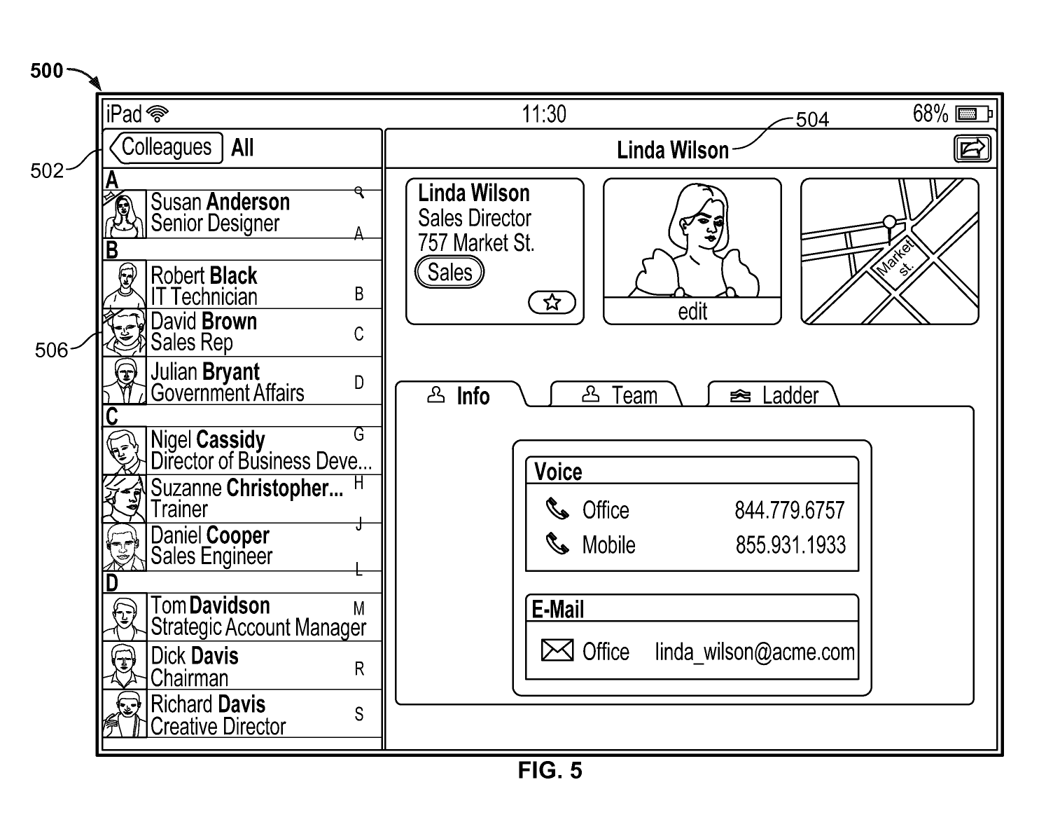

FIG. 5 illustrates an example interface 500 for accessing group information. The information can be presented to a user on a user device, as described in reference to FIG. 1. The interface 500 includes a group information display 502 and a profile display 504. In FIG. 5, the group information display 502 is shown as having been expanded, e.g., upon selection of a particular group. In FIG. 5, the group information display 502 displays information describing all of the individuals that are associated with tenant in response to a user selection of the “All” group. The group information display 502 displays information describing particular individuals, including, for example, a name, job title, image associated with the individual, and an indication that the individual is favorite 506.

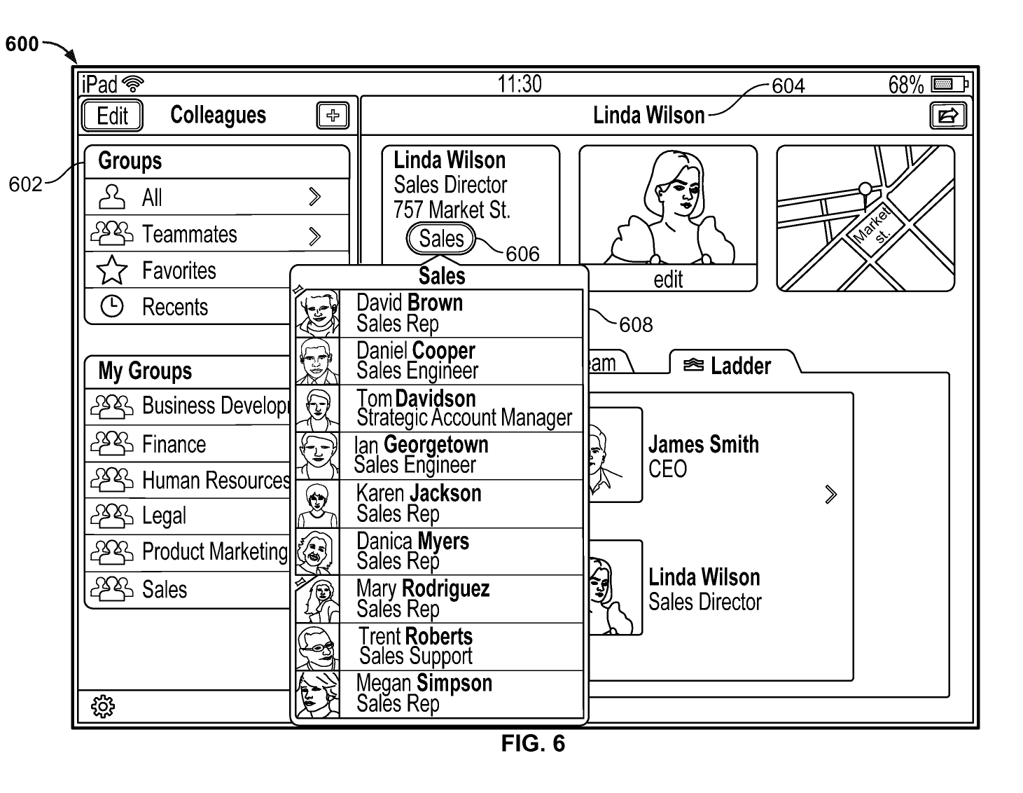

FIG. 6 illustrates an example interface 600 for accessing group information from a profile of a particular individual. The information can be presented to a user on a user device, as described in reference to FIG. 1. The interface 600 includes a group information display 602 and a profile display 604. In FIG. 6, the profile display 604 includes a user interface element, e.g., a button 606, for accessing a group listing of individuals that are in a group associated with the particular individual. The button 606 indicates a name of the group (“Sales”) associated with the particular individual. A group information pop-up display 608 can be an overlay that appears once the button 606 is selected. The group information pop-up display 608 provides a listing of individuals that are associated with the group (“Sales”) and information describing the individuals, including, for example, a name, job title, image associated with the individual, and an indication that the individual is favorite.

FIG. 7 illustrates an example interface 700 for accessing team information from a profile of a particular individual. The information can be presented to a user on a user device, as described in reference to FIG. 1. The interface 700 includes a group information display 702 and a profile display 704. The profile display 704 includes a region 720 for displaying team information, e.g., a listing of other individuals 724 that are associated with the same team as the individual. The team information can include contact information, e.g., respective names, job titles, phone numbers, images, of the particular individual's team members. Individuals referenced in the listing 724 can be selected in the listing 724 to access a profile display, e.g., profile display 404, of a particular individual. The region 720 also includes buttons 722 and 726 for accessing information about the particular individual and ladder information, respectively, as described in FIGS. 6 and 8.

FIG. 8 illustrates an example interface 800 for accessing ladder information from a profile of a particular individual. The information can be presented to a user on a user device, as described in reference to FIG. 1. The interface 800 includes a group information display 802 and a profile display 804. The profile display 804 includes a region 822 for displaying ladder information, e.g., a hierarchical listing describing the individual's supervisors and subordinates. The ladder information can include contact information, e.g., respective names, job titles, phone numbers, images, of the particular individual's supervisors and/or subordinates. In some implementations, the ladder information can display additional relationships between individuals referenced in the ladder information, for example, in the form of organizational charts and/or trees. The region 822 also includes buttons 826 and 828 for accessing information about the particular individual and team information, respectively, as described in FIGS. 6 and 7.

FIG. 9 illustrates an example interface 900 for presenting information that describes conference rooms associated with a particular tenant. The interface can be provided in a company conference rooms application program, e.g., a web browser or mobile application on a user device, that is configured to present information describing conference rooms that are associated with a particular tenant. The information can be presented to a user on a user device, as described in reference to FIG. 1. The interface 900 includes a button 902 (“Now”) for viewing a listing of conference rooms that are currently available for reservation. A button 904 (“Bookings”) can be selected for viewing a listing of conference that the user has booked. Further, a button 906 (“Settings”) can be selected to set one or more options.

The interface 900 depicts a listing of currently available conference rooms that are associated with the particular tenant. The listing provides, for each conference room, a region, e.g., a region 908, that describes the respective conference room, e.g., a name, location information, availability information, and one or more conference room images. The region can also include information, e.g., text and/or images, describing features 910, e.g., seating capacity and availability of equipment (e.g., projectors or video conferencing) that are available in a conference room. Each conference room region can include a button, e.g., button 912, for booking the respective conference room. Users can scroll the interface 900 to view additional rooms that are not initially visible in the interface 900.

FIG. 10 illustrates an example interface 1000 for presenting information that describes conference rooms associated with a particular tenant. The information can be presented to a user on a user device, as described in reference to FIG. 1. The interface 1000 depicts a listing of currently available conference rooms that are associated with the particular tenant.

The listing provides, for each conference room, a region, e.g., region 1010, having information that describes the respective conference room. Each conference room region can include a button, e.g., button 1012, for booking the respective conference room. In some implementations, upon booking a conference room, a duration pop-up window 1016 is displayed. The user can use the duration pop-up window to set a duration for the conference room booking. In some implementations, the duration pop-up window 1016 is displayed upon user selection of the duration button 1014.

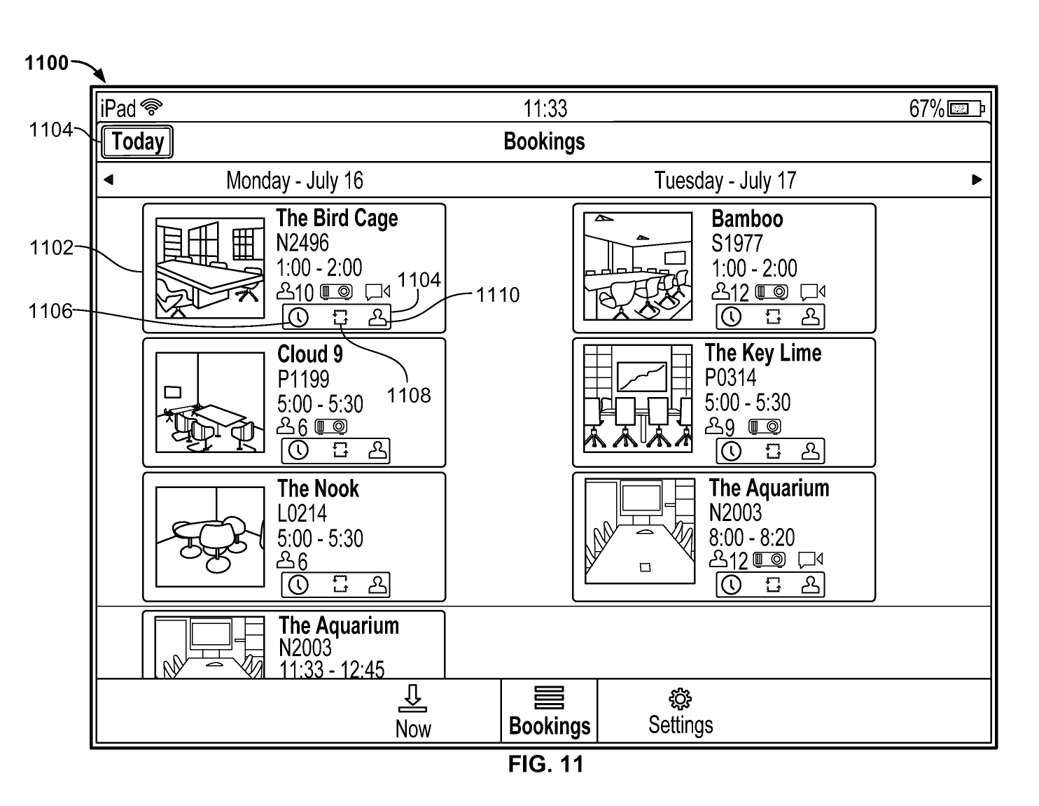

FIG. 11 illustrates an example interface 1100 for presenting information that describes conference rooms associated with a particular tenant. The information can be presented to a user on a user device, as described in reference to FIG. 1. The interface 1100 depicts a listing of conference rooms that the user has booked. The listing provides, for each conference room, a region, e.g., region 1102, that describes the respective conference room

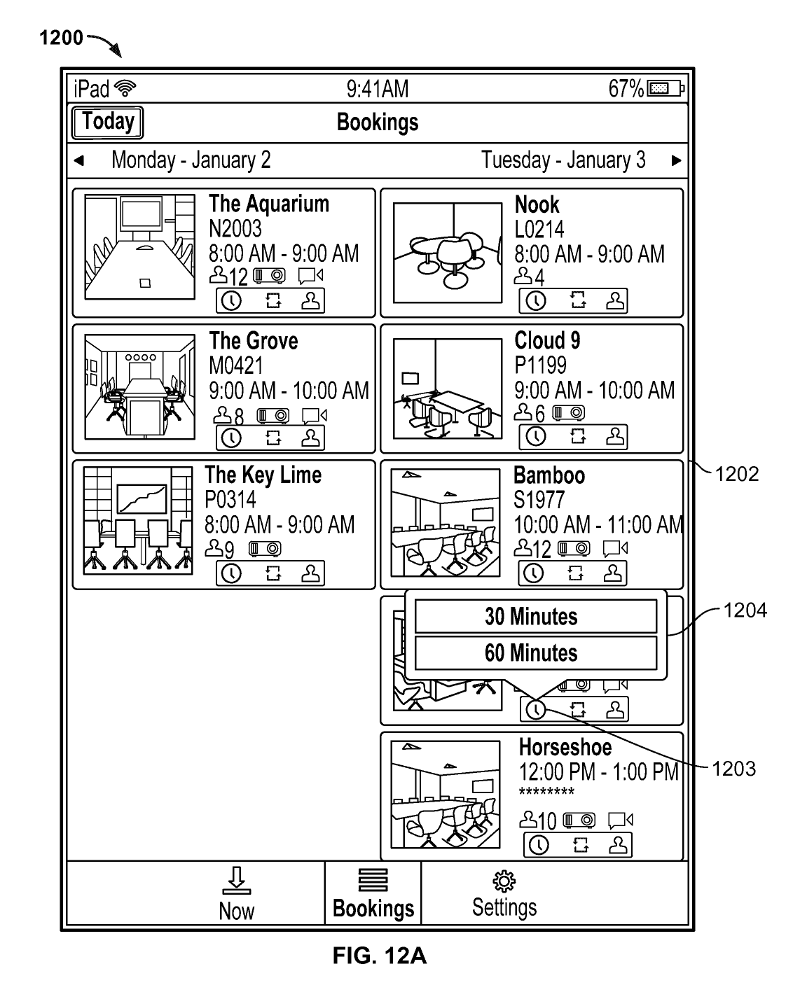

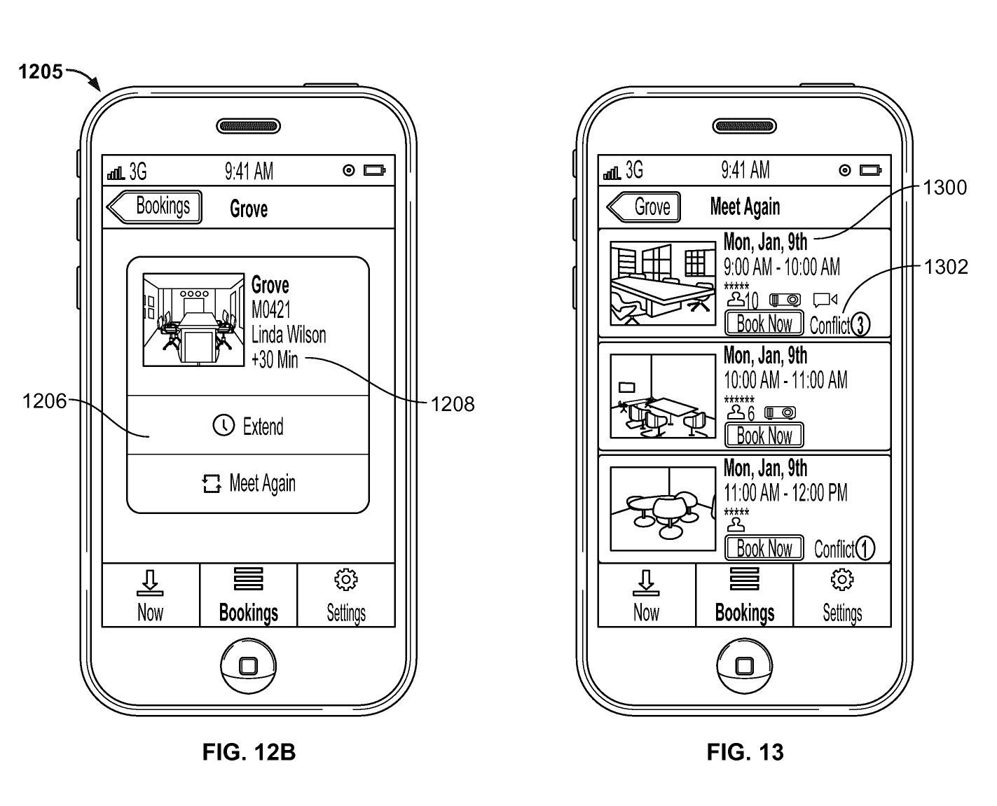

In some implementations, each region includes scheduling options 1104 for the respective conference room. A user can select an “Extend” scheduling option 1106 to extend the conference room reservation time, as described in reference to FIGS. 12A and 12B. A user can also select a “Meet Again” scheduling option 1108 to schedule another meeting with the same individuals that are in the scheduled meeting, as described in reference to FIG. 13. An option 1110 can be selected to view individuals that are scheduled to meet in the conference room at the scheduled time. In some implementations, the scheduling options 1104 are accessible only to users that initially organized the meeting or users that have been given authority to organize meetings, e.g., meeting organizers.

FIG. 12A illustrates an example interface 1200 for extending a conference room reservation time. The interface 1200 includes a region 1202 that describes a conference room. The region 1202 also includes an “Extend” scheduling option 1203 to extend the conference room reservation time. In some implementations, a pop-up overlay 1204 is displayed when a user selects the scheduling option 1203. A user can select options in the pop-up overlay 1204 to extend the conference room reservation time. In some implementations, the pop-up overlay 1204 provides incremental options, e.g., 30 minutes, 60 minutes or 90 minutes, for extending the conference room reservation time.

FIG. 12B illustrates another example interface 1205 for extending a conference room reservation time. The interface 1205 describes a conference room. The interface 1205 also includes an “Extend” scheduling option 1206 to extend the conference room reservation time. In some implementations, a pop-up window 1208 is displayed when a user selects the scheduling option 1206. A user can select options in the pop-up window 1208 to extend the conference room reservation time. In some implementations, the pop-up window 1208 provides incremental options, e.g., 30 minutes, 60 minutes, or 90 minutes, for extending the conference room reservation time.

FIG. 13 illustrates an example interface 1300 for scheduling a follow-up conference room meeting. In situations where a follow-up meeting is needed, a user can select a “Meet Again” scheduling option, as described above. The “Meet Again” option can be used to schedule another meeting with the same individuals that are in the scheduled meeting.

In some implementations, a user can select the “Meet Again” option and can specify a time and/or date for the next meeting. The interface 1300 can display a listing of conference rooms that are available at a time and/or date that was specified by the user. For each conference room in the listing, the interface 1300 can also indicate a count of individuals, e.g., indicator 1302, that are scheduled to attend the meeting but have a conflict for the specified time and/or date. In some implementations, meeting conflicts are determined based on calendar data associated with the individuals scheduled to attend the meeting.

Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions, encoded on computer storage medium for execution by, or to control the operation of, data processing apparatus. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A method performed by data processing apparatus, the method comprising:
receiving a user login request originating from a user device, the user login request including a user identifier;
authenticating, based on the user identifier, the user as having access to information associated with a particular tenant of a plurality of tenants;
identifying a tenant specified theme associated with the particular tenant of a plurality of tenant themes, the theme being specified by the tenant for use in presenting data to authenticated users;
obtaining data associated with the particular tenant; and
providing the data associated with the particular tenant to the user device for presentation, wherein the data is presented on a user interface of the user device, the data being formatted based on the identified tenant theme.

2. The method of claim 1, further comprising:
receiving a user request for tenant data;
obtaining tenant data responsive to the request; and
providing the response to the user device, wherein the response is presented in the user interface on the user device, the response being formatted based on the particular tenant theme.

3. The method of claim 2, wherein the user request is for information associated with one or more individuals that are associated with the particular tenant.

4. The method of claim 3, wherein obtaining data associated with the particular tenant comprises obtaining profile and group information for a plurality of individuals associated with the particular tenant.

5. The method of claim 3, wherein the information associated with the one or more individuals includes one or more of a respective name, title, contact information, department information, team information, or supervisor information for respective users of the one or more individuals.

6. The method of claim 3, wherein at least a portion of the information associated with the one or more individuals is stored in a cache, and wherein obtaining tenant data responsive to the request comprises determining a responsive portion of the data stored in the cache.

7. The method of claim 6, wherein, when responsive data cannot be determined from the cache, obtaining tenant data responsive to the request from data processing apparatus associated with the particular tenant.

8. The method of claim 7, further comprising:
updating the cache to include the obtained data responsive to the request.

9. The method of claim 1, wherein the particular tenant theme defines, for the particular tenant, a graphical user interface configuration, including one or more of logo images, background images, or a color scheme.

10. The method of claim 2, wherein the user request is for information associated with one or more conference rooms that are associated with the particular tenant.

11. The method of claim 10, wherein obtaining data associated with the particular tenant comprises obtaining a listing of the one or more conference rooms.

12. The method of claim 10, wherein the information associated with one or more conference rooms includes a respective conference room name, location information, availability information, one or more conference room images, and a description of conference room features.

13. The method of claim 10, further comprising:
receiving a conference room reservation request from a user operating the user device, the conference room reservation request specifying a particular conference room and a reservation duration;
determining whether the particular conference room is available for the reservation duration; and
in response to determining that the particular conference room is available for the reservation duration, reserving the particular conference room for the reservation duration.

14. A system comprising:
one or more computers and one or more storage devices storing instructions that are operable, when executed by the one or more computers, to cause the one or more computers to perform operations comprising:
receiving a user login request originating from a user device, the user login request including a user identifier;
authenticating, based on the user identifier, the user as having access to information associated with a particular tenant of a plurality of tenants;
identifying a tenant specified theme associated with the particular tenant of a plurality of tenant themes, the theme being specified by the tenant for use in presenting data to authenticated users;
obtaining data associated with the particular tenant; and
providing the data associated with the particular tenant to the user device for presentation, wherein the data is presented on a user interface of the user device, the data being formatted based on the identified tenant theme.

15. The system of claim 14, further comprising:
receiving a user request for tenant data;
obtaining tenant data responsive to the request; and
providing the response to the user device, wherein the response is presented in the user interface on the user device, the response being formatted based on the particular tenant theme.

16. The system of claim 15, wherein the user request is for information associated with one or more individuals that are associated with the particular tenant.

17. The system of claim 16, wherein obtaining data associated with the particular tenant comprises obtaining profile and group information for a plurality of individuals associated with the particular tenant.

18. The system of claim 16, wherein the information associated with the one or more individuals includes one or more of a respective name, title, contact information, department information, team information, or supervisor information for respective users of the one or more individuals.

19. The system of claim 16, wherein at least a portion of the information associated with the one or more individuals is stored in a cache, and wherein obtaining tenant data responsive to the request comprises determining a responsive portion of the data stored in the cache.

20. A non-transitory computer storage medium encoded with instructions that, when executed by one or more computers, cause the one or more computers to perform operations comprising:
receiving a user login request originating from a user device, the user login request including a user identifier;
authenticating, based on the user identifier, the user as having access to information associated with a particular tenant of a plurality of tenants;
identifying a tenant specified theme associated with the particular tenant of a plurality of tenant themes, the theme being specified by the tenant for use in presenting data to authenticated users;
obtaining data associated with the particular tenant; and
providing the data associated with the particular tenant to the user device for presentation, wherein the data is presented on a user interface of the user device, the data being formatted based on the identified tenant theme.
